(19) United States
(12) Patent Application Publication
(10) Pub. No.: US 2016/0186624 A1
(43) Pub. Date: Jun. 30, 2016

(54) HOLLOW BODY HAVING AN INTEGRATED OIL SEPARATING DEVICE

(71) Applicants: Juergen Meusel, Dittmannsdorf (DE); Ulf Mueller, Chemnitz (DE)

(72) Inventors: Juergen Meusel, Dittmannsdorf (DE); Ulf Mueller, Chemnitz (DE)

(21) Appl. No.: 13/813,002

(22) PCT Filed: Jun. 17, 2011
(86) PCT No.: PCT/EP2011/060116

§ 371 Date: Jul. 10, 2013

(30) Foreign Application Priority Data
Aug. 10, 2010 (DE) 10 2010 033 955.5

(51) Int. Cl. F01M 13/04; B04C 3/06

(52) U.S. Cl. CPC F01M 13/04; B04C 3/06; B04C 2003/006

(57) ABSTRACT

The invention relates to a hollow body (2) formed at least in regions as a hollow cylinder and having an integrated oil separating device, wherein a vortex generator (4) is disposed in a hollow space (3) of the hollow body (2), wherein the hollow body (2) comprises at least one inlet opening (9) on the jacket side for introducing gas charged with oil into the hollow space (3) and wherein the hollow body (2) comprises at least one discharge opening for discharging separated oil and for discharging gas freed of oil. According to the invention, an oil separating ring (5) is disposed within the hollow space (3) and downstream of the vortex generator (4) as seen in the flow direction. The invention further relates to a cylinder head cover having such a hollow body (2).

The present invention relates to a hollow body formed at least partially as a cylindrical tube and hereinafter referred to as a hollow body, having an integrated oil separator, where a vortex generator is provided in a cavity of the hollow body, the hollow body having on one end at least one intake port for introducing gas charged with oil into the cavity and at least one outlet port for discharging separated oil and gas freed of oil. The oil separator is envisioned, in particular, for use with regard to the cylinder head cover on combustion engines. Correspondingly, the invention further relates to a cylinder head cover having such a hollow body with integrated oil separator.

The term “vortex generator” relates in the scope of the present invention, in particular, to a body that itself includes flow passages for gas charged with oil or that forms together with the hollow body inside which it is provided flow passages for gas charged with oil, the flow passages forming the gas flow into a vortex. The vortex causes separation of the oil along the walls of the flow passages.

Losses due to leakage have been observed in combustion engines and piston compressors in practical applications that must be blamed on incomplete sealing action. These leakage losses are referred to as blow-by gas and contain a considerable amount of oil. Relative to combustion engines it is therefore customary to recirculate the blow-by gas that occurs at the camshaft into the intake stroke of the combustion engine. In order to minimize oil losses due to blow-by gas, on the one hand, and ensure optimal combustion as well as a minimal environmental impact, on the other hand, it is known in the art to subject blow-by gas to an oil separation step in order to recirculate the separated oil into the oil circuit. Correspondingly, the development of oil separation systems that are as simple as possible while, nevertheless, reliable and efficient is sought.

A hollow body with integrated oil separator having the characteristics as outlined above is known in the art from DE 10 2004 011 177 [U.S. Pat. No. 7,743,742]. A helical vortex generator is provided inside a cylindrical housing that induces rotation to the blow-by gas that is routed through it, and which is also referred to as oil mist or oil-entraining gas, due to the flow along the helical passage created by the vortex generator. This rotation is causes oil droplets to be thrown outward and thus collect on the walls of the hollow body whence they can subsequently be transported away. To separate oil as completely as possible, aside from a change of the pitch and/or diameter of the individual screwthreads, an arrangement of a plurality of vortex generators provided in series is proposed, it also being possible to change the direction of rotation within the different vortex generators. By disposing a plurality of vortex generators in series, it is possible to improve the separation output; however, associated undesired flow and pressure losses can result.

Furthermore, also known are multiple-step separation devices that are composed as separate components made up of several modules. Separators of this kind require an undesirably large mounting space, particularly if they are to be integrated into a cylinder head cover. A separator of this kind is known, for example, from DE 101 27 820 [U.S. Pat. No. 6,860,915].

With this background in mind, the object of the present invention is to provide a hollow body of this type with an integrated oil separator that allows for improved oil separation from blow-by gases with the least possible manufacturing-related technical complexity.

According to the invention, this object is achieved by a hollow body having the characteristics set forth in claim 1. According to the invention, the vortex generator that is integrated in the hollow body, to form therein a first oil separating step, is followed downstream in the flow direction by an oil separator acting as a second oil separating step. Advantageously, the vortex generator and the oil-separating ring are coaxially mounted in the cavity of the hollow body.

The vortex generator is advantageously configured as a body extending axially of the hollow body and that has around its outer surface at least one screwthread or forms at least one screwthread, such that the screwthread creates between the body of the vortex generator and the inner surface of the hollow body at least one flow path for routing the introduced oil-entraining gas and for the separation of oil particles on the inner surface. The oil that is to be freed of the blow-by gas therein is able to flow into the hollow body through the intake port.

The hollow body can, for example, have the shape of a simple pipe, the intake port being constituted by an open end of the pipe. When the blow-by gas enters through the intake port at the end, the flow is axially directed, or at least substantially axially directed, at the vortex generator as a first oil-separating step, and then the vortex generator causes a rotation of the gas that is to be freed of oil. Aside from the intake port on the end, it is also possible, however, to provide for radial openings.

In a particularly preferred embodied example of the invention, the body of the vortex generator includes at least a partial second screwthread. This creates two at least partial and parallel flow paths. The configuration of the hollow body with two flow paths thereof is advantageously envisioned in the upstream region of the vortex generator; the intake ports there are provided such that the inflowing oil-entraining air (i.e. blow-by gas) is routed—substantially without fluid-mechanical resistance and/or with minimized fluid-mechanical resistance—into the hollow body. Due to the fact that the blow-by gas is essentially sucked into the inside of the cavity of the hollow body by a negative pressure that is created therein, this negative pressure is maintained by minimizing flow resistance. The necessary negative pressure can be generated, for example, by a pump coupled to the cavity of the camshaft. The second screwthread is advantageously configured such that it extends across approximately one half of a complete screw revolution of 360°. Without limitation, it is also possible to provide for three or even more parallel flow paths that are separated from each other by the screwthreads.

The screwthreads or each screwthread can be configured such that their pitches vary. Preferably, both screwthreads have the same pitch, the pitch overall being prescribed by the first screwthread and/or depending on the requirements thereof. Advantageously, the pitch varies such that the distances of the flanks of a screwthread, and thereby the cross-section of the flow paths or flow passages constituted by the screwthread flanks become smaller. This causes the blow-by gas to be further accelerated along the flow path, and the negative pressure that exists in the cavity of the hollow body is substantially maintained.

To discharge the separated oil and/or the blow-by gas that has been cleaned of the oil, the hollow body can be formed with one or a plurality of outlet ports, a flow-direction element being provided in the cavity of the hollow body downstream of the outlet ports to redirect the gas that has been cleaned of the oil toward the radial outlet port(s) and thence to the outside. The separated oil flowing in the flow direction along the inner surface of the hollow body is routed through and discharged via a single or a plurality of oil-outlet ports that are provided upstream in the flow direction of the radial gas outlet ports and out of the hollow body. Furthermore, the outlet ports can also be at an axial end that is opposite the intake port.

According to another preferred embodied example of the invention, a bypass passage is integrated in the vortex generator. The bypass passage can be formed by an axially throughgoing bore in the vortex generator that is axially open at both ends. The bypass bore can be unblocked, depending on the pressure, by an integrated bypass valve. If according to a preferred embodiment at least one radial opening is provided in addition to the end intake port according to the invention, it is possible to provide for a functional distribution as well regarding these different intake ports. Correspondingly, it is possible, for example, that at least the radial opening opens into a flow path of the vortex generator, while the end intake port is associated with the bypass valve. An embodiment of this kind achieves the advantage that the radial intake port generates a certain vortex for the vortex generator that is intensified by the spiral-type structure of the flow rule. On the other hand, a bypass valve can be axially biased by pressure at the end intake port, for example, against the force of a spring, the blow-by gas flowing through the bypass bore, however, being preferably in the end redirected in such a way that it is routed across the oil-separating ring provided downstream thereof.

A further aspect of the present invention addresses an is improvement of the separating output, where particularly a variable adjustment to low and high flow volumes is made possible. For this purpose, in a multiple-passage configuration, the vortex generator can include a valve body at the upstream end against which the flow from the intake port is directed, the valve body being at least able to unblock and block at least one of the flow paths between the screwthreads. The valve body can be especially easily actuated in a pressure-controlled manner if a first pressure is present between the vortex generator and an oil-separating ring, a second pressure is present at the upstream end of the vortex generator, and the at least one flow path is unblocked or blocked depending on the pressure differential between the second and first pressures.

Correspondingly disclosed is an integrated oil separator or a first step of the oil separator in the form or a vortex generator that can be controlled dependent on the differential pressure between the upstream and downstream ends of the vortex generator, meaning dependent on the volume flow. Instead of a fixed geometry that constitutes a compromise for different flow volumes and pressure differentials occurring therein, the described preferred embodiment allows for a good separating efficiency with a simultaneously limited increase of the pressure loss across a wide range of the volume flow of the blow-by gas.

Regarding the function of the vortex generator, it must be taken into consideration that in order to generate the necessary centrifugal force for an effective oil separation, a certain flow rate and, correspondingly, a certain differential pressure should be present. To maintain the desired pressure with a minimal volume flow of blow-by gas, the described preferred embodiment provides for a small flow cross-section in that access to only one of the plurality of the flow paths is opened. The separation by one of the flow paths therein can be optimized for a pressure differential and a corresponding flow rate that already occur at small flow volumes.

To avoid excessive pressure losses when the volume flow increases, the valve body, which operates dependent on pressure, causes an enlargement of the flow cross-section in that a further flow path is opened between the screwthreads or in that a plurality of flow paths are unblocked. Correspondingly, it is expedient for access to at least one of the flow paths to be blocked below a preset pressure differential and unblocked by the valve body when the preset pressure different is exceeded.

Preferably, a configuration provides for a vortex generator that includes at least three screwthreads and correspondingly three flow paths, second and third flow paths being sequentially unblocked by the valve body as the pressure differential increases.

As explained in further detail below, the valve body can be a slide, bolt or the like, and the valve body is closed by the effective pressure differential, for example, against the force of a spring. In particular, it can be provided that, during the sequential unblock of further flow paths, the corresponding accesses are first opened only partially and completely opened only at the end with a further stoke. It is usually provided that, when a great pressure differential applies, in an end position of the valve body, all the flow paths are opened in order to provide a maximum cross-section of flow for the oil separation.

Since the separation of oil from the blow-by gas is to occur even with small flow volumes, in a preferred embodiment of the invention access to a first flow path is always not completely closed. Falling within the scope of the invention therein are configurations in which access to a first flow path is completely opened in a first end position at a low pressure differential or partially covered by the valve body, and thereby partially closed, in order to cause a further reduction of the flow cross-section and/or an increase of the differential pressure with especially small flow volumes.

To be able to discharge very large flow volumes of blow-by gas that can occur, for example, when great loads are applied to the combustion engine or when the combustion engine is defective, it is possible to provide, independently of the flow paths constituted between the screwthreads, a further flow path in form of the previously described bypass passage as well that extends parallel relative to the flow paths that are delimited by the screwthreads and is provided at the upstream end with a previously described bypass valve.

For the valve body to be adjusted between the upstream and downstream end of the vortex generator depending of the pressure differential, it is necessary for the first pressure to be in effect on one end of the valve body and the second pressure to be in effect on the other end of the valve body. In particular, it is possible to envision the bypass passage of the vortex generator for this purpose that connects one end of the valve body with the space between vortex generator and oil-separating ring.

Different possibilities emerge based on the scope of the invention regarding further configurations of the vortex generator and the valve body. Correspondingly, the valve body can be provided inside a chamber of the vortex generator that is open toward the upstream end, the flow paths being connected by respective openings with the chamber. Axial displacement of the valve body into the chamber unblocks the openings for the individual flow paths one after the other, and preferably, as described previously, the first flow path is at least not completely closed off in each position.

To be able to unblock the individual openings, different steps are basically possible. Correspondingly, the openings that open into the chamber can be provided, for example, in a radial plane of the chamber, the valve body includes at the end thereof that is directed toward the upstream end recesses of different depths working with each individual opening. According to a preferred configuration of the invention, it is envisioned, however, that the openings for the different flow paths are offset axially relative to each other axially and the valve body is a simple inner pin. A configuration of this kind is characterized by especially simple construction, and the integration of the valve body inside the vortex generator allows for a minimization of the construction space. Configuring the valve body as an inner axially displaceable pin makes it easily possible for more than three flow paths to be opened and closed, this inner pin also allowing for simple integration of a bypass valve.

The motion of the inner pin is usually delimited by stops, the inner pin being secured against falling out at the same time. Possible stops are, for example, steps within the chamber, rings, screws, or the like. When the inner pin is mounted during the manufacture of the hollow body from the upstream end of the vortex generator, it is easily possible to delimit the range of motion of the pin toward the downstream end by a step and toward the upstream end by a separate element in the form of a ring or a screw.

In the described configuration of the valve body as an inner pin it must fit a precisely; on the one hand, a precise fit allows for the permanent mobility of the inner pin and, on the other hand, for a sufficient sealing action of the bolt relative to the chamber.

While the described configuration only provides for the hollow body to have the end intake port as a necessity in order to apply, on the one hand, the second pressure upon the valve body, and to route, on the other hand, the blow-by gas to the vortex generator, according to an alternative configuration, the hollow body can have, in addition to the end intake port, radial openings that are associated with respective flows path formed between the screwthreads, the valve body being a sliding sleeve for controlling direct entry of the blow-by gas into the individual flow paths as a function of pressure. The intake port on the end is provided for applying the second pressure from the upstream end to the valve body that is a sliding sleeve.

In the described embodiment of the valve body as a sliding sleeve, it is preferably provided on the vortex generator locked against rotation and provided with apertures working with the radial openings of the hollow body in order to sequentially unblock the individual flow paths depending on the pressure differential. In particular, the radial openings of the hollow body can have the shape of bores and be provided spaced angularly around the hollow body, at least some of the apertures in the sliding sleeve being slots extending axially of the hollow body. With an arrangement of the radial openings along a circumferential line, there results the advantage that the totality of the flow paths of the vortex generator can have the same usable length for the purpose of the oil separation.

Also when embodying the valve body as a sliding sleeve, it is possible to envision a force support in a particularly simple manner using a spring, the sliding sleeve also allowing for integrating a bypass valve.

A cylinder head cover with the previously described hollow body is also the subject matter of the present invention. The hollow body can be provided on the inside of the cover and extend, particularly in the mounted state, parallel relative to a camshaft that is covered up by the cylinder head cover. The envisioned measures allow both individually or in combination for an overall reduction of the construction space.

The blow-by gas that must be cleaned flows through the end intake port and/or further intake ports into the hollow body. To avoid that the rotating camshaft throws oil directly into these openings, the use of elements such as baffle plates or shutters is possible that cover up a direct visual line between the end intake port and/or further openings.

The cylinder head cover includes a cover body that covers up at least a camshaft of an engine block. The hollow body according to the invention can be manufactured as a separate part and mounted on the body of the cover. Furthermore, there is the possibility of manufacturing the hollow body in one piece with and as a portion of the cover body. It is also conceivable for the hollow body according to the invention to be formed by the cover body, on the one hand, and the cover body to made of a separate part, on the other hand. The separate part and a corresponding portion of the cover body can be combined, for example, like two half-shells.

Below, the invention will be described in further detail based on a drawing representing a single embodiment. Therein:

FIG. 1 is an axial section through a hollow body according to the invention with integrated oil separator;

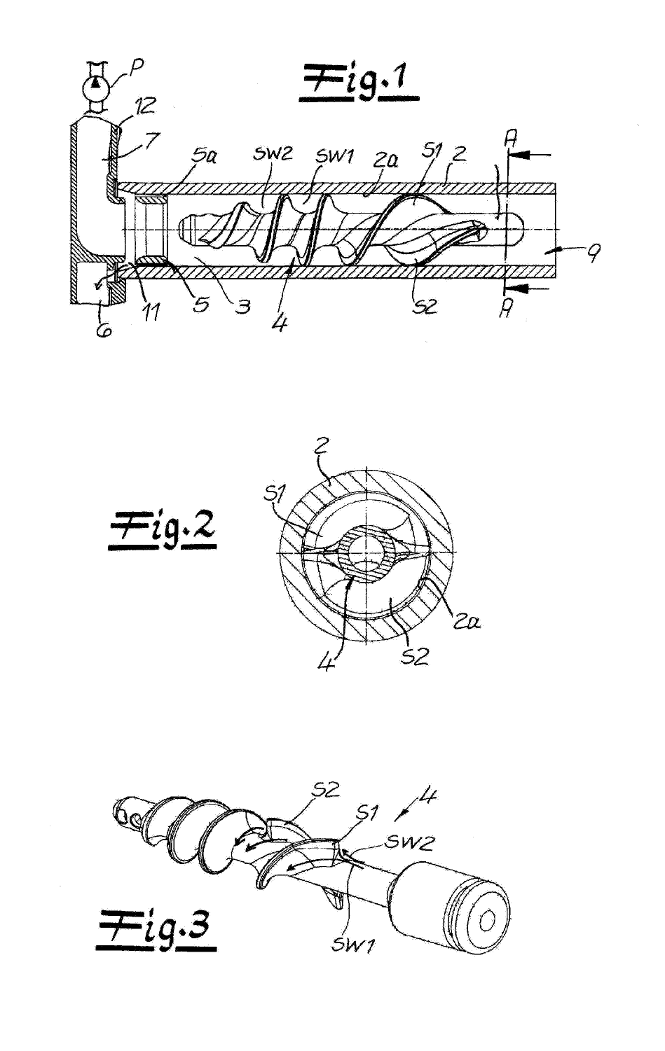

FIG. 2 is a cross section through a hollow body along line A-A of FIG. 1;

FIG. 3 is a schematic view of a vortex generator to be integrated in the hollow body, seen in a possible embodiment;

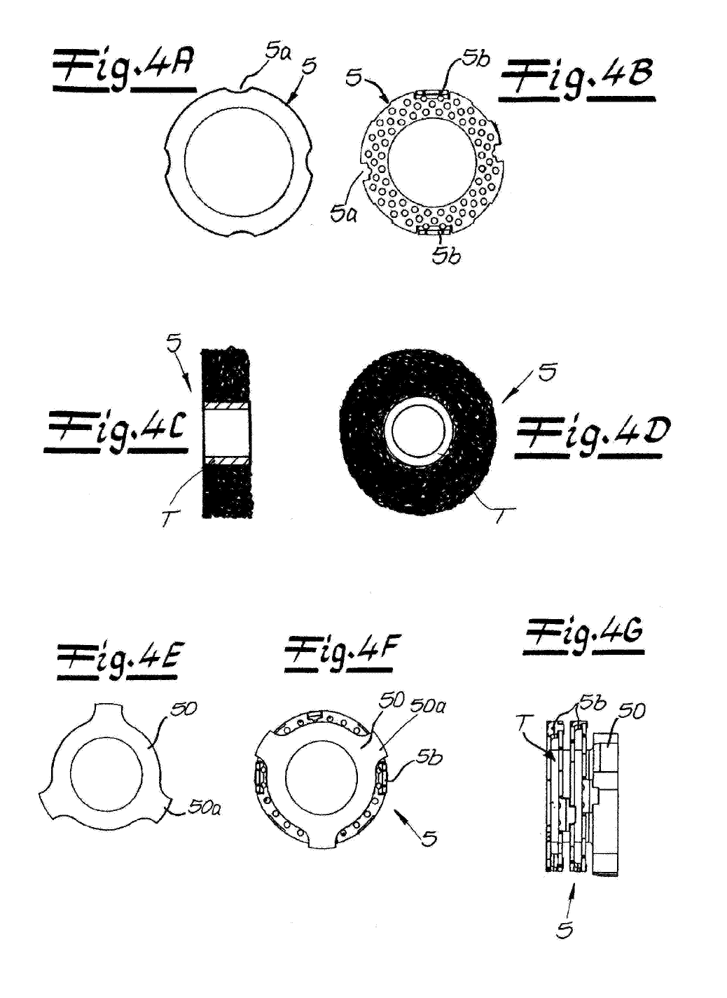

FIGS. 4a to 4g show an oil-separating ring in different possible embodiments;

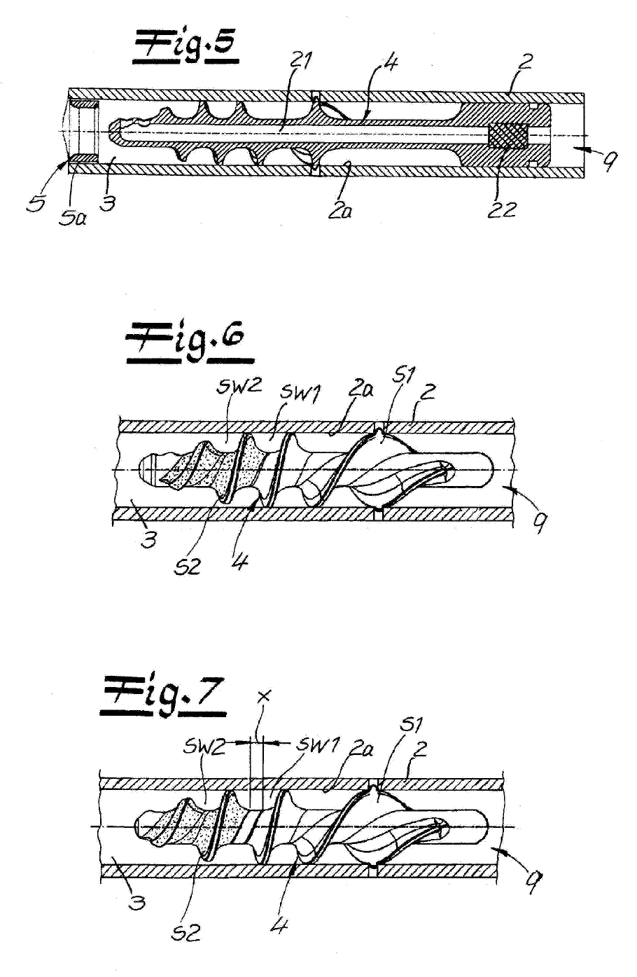

FIG. 5 is a section through the hollow body having an integrated oil separator with bypass passage;

FIGS. 6 and 7 are sections through the hollow body having an integrated vortex generator with axially displaceable screwthread;

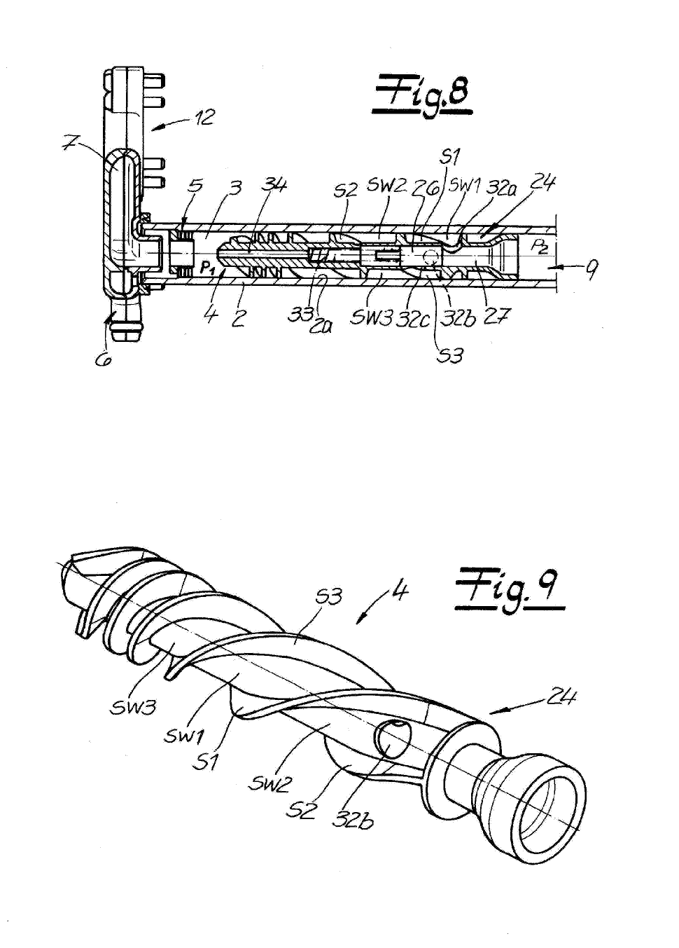

FIG. 8 shows an alternative configuration of the hollow body according to the invention;

FIG. 9 is a perspective view of the vortex generator according to FIG. 8;

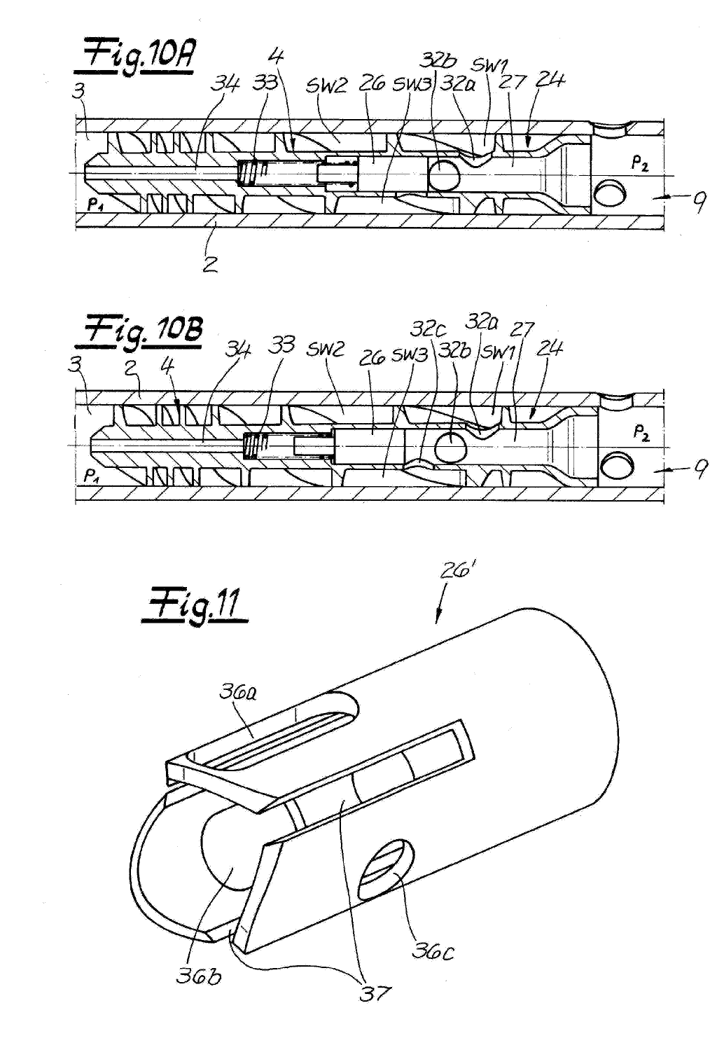

FIGS. 10A and 10B are detail views of the hollow body as shown in FIG. 8 with deviating functional positions of a valve body;

FIG. 11 is a perspective view of an alternative configuration of a valve body;

FIG. 12 is a sectional view of an alternative configuration of the hollow body with the valve body as shown in FIG. 11;

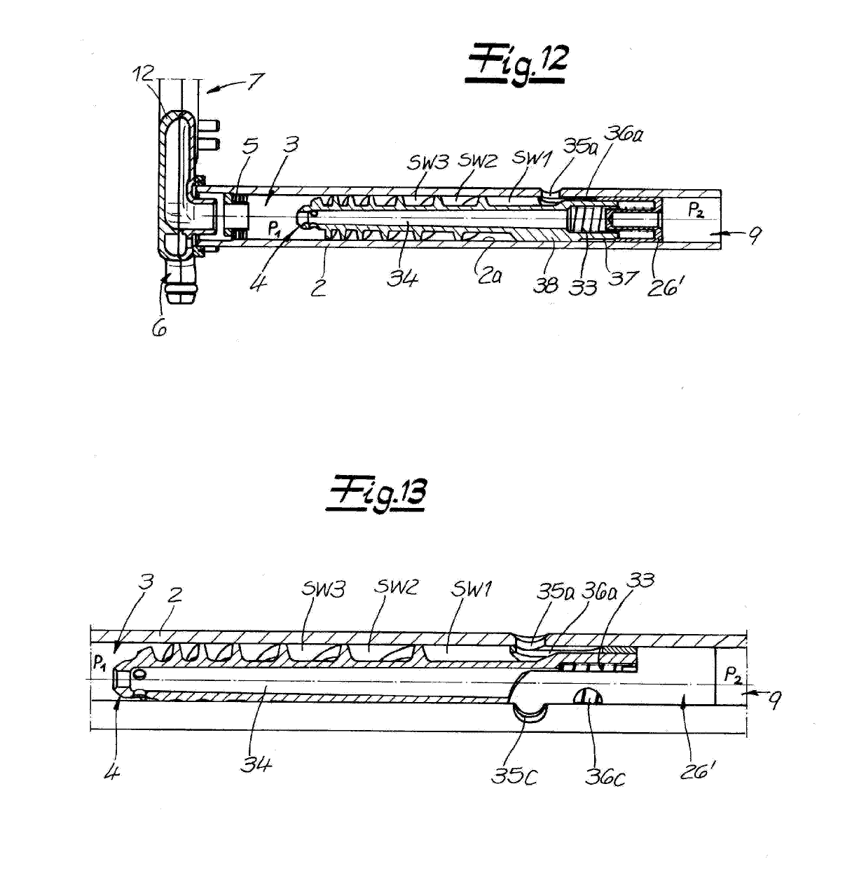

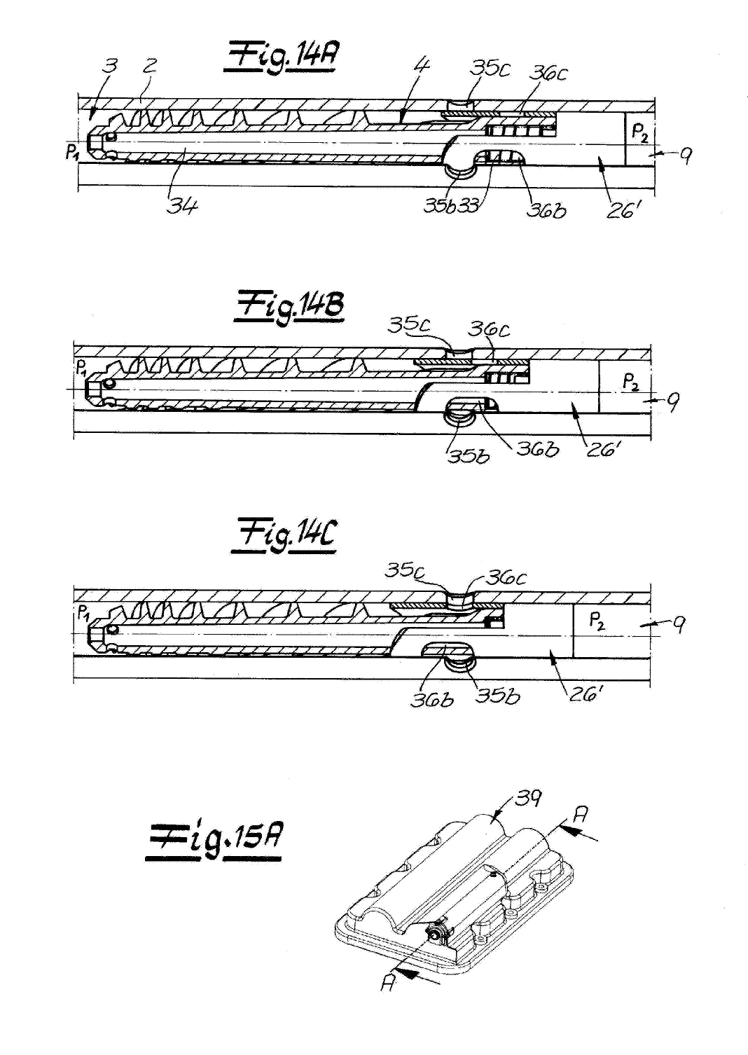

FIG. 13 is a sectional detail view of the hollow body as shown in FIG. 12;

FIGS. 14A to 14C are sectional detail views of the hollow body as shown in FIG. 12 in a view that is rotated by 120° relative to the view as seen in FIG. 13, seen with different functional positions of the valve body as shown in FIG. 11;

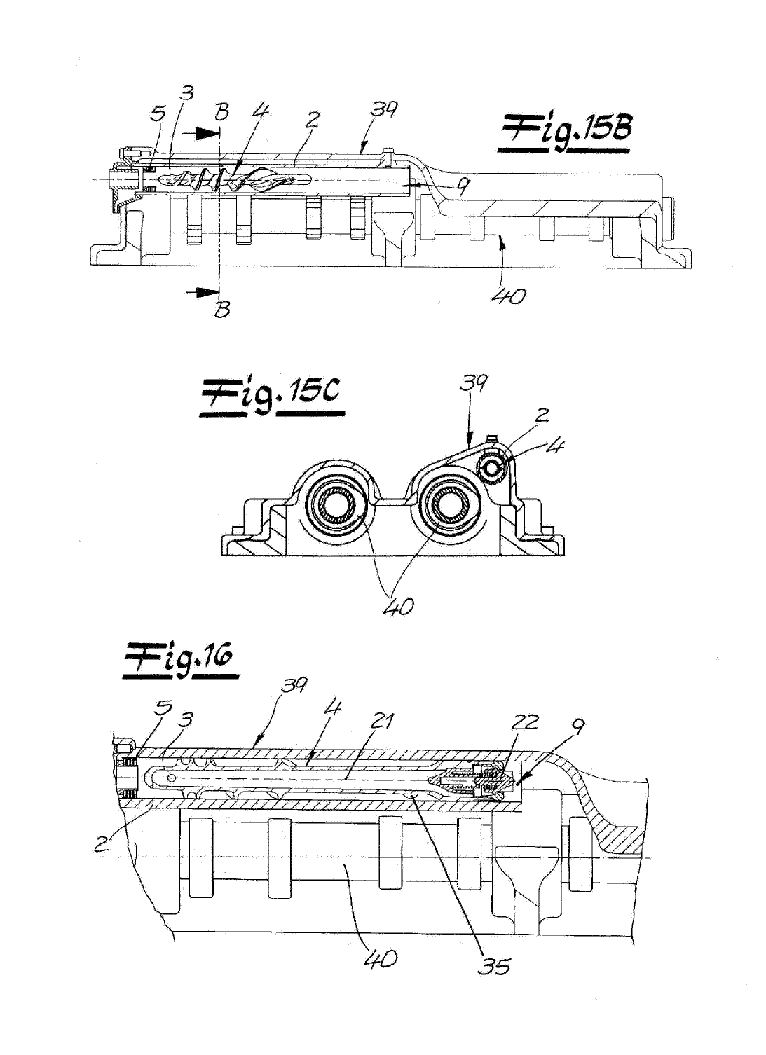

FIGS. 15A to 15C show a cylinder head cover with a hollow body for separating blow-by gas, seen in a perspective view in FIG. 1A, in axial section according to line A-A of FIG. 15A, and in a cross-section along line B-B of FIG. 15B; and

FIG. 16 is an axial sectional view of an alternative is configuration of the cylinder head cover.

FIG. 1 is a schematic view of a hollow body 2 according to the invention with an integrated oil separator. The oil separator therein is formed by the hollow body 2 having a cavity 3, a vortex generator 4 provided inside the cavity 3, an oil-separating ring 5 as well as an oil outlet conduit 6 and a gas outlet conduit 7. The hollow body 2 has an intake port 9 provided at an upstream end. Blow-by gas that is to be cleaned of oil flows into the cavity 3 through the intake port 9. Centrifugal forces that act upon the vortex generator 4 cause heavier oil particles in the blow-by gas to be pressed against an inner surface 2a of the cavity 3 and be separated there as an oil film.

Provided downstream of the intake port 9 and acting as first separating step is the vortex generator 4 that is substantially configured as volute and is formed along its outer surface with at least one screwthread S1, S2. The screwthreads S1, S2 create flow paths SW1, SW2 between the body of the vortex generator 4 and the inner surface 2a of the hollow body 2 for routing the introduced oil-entraining gas (oil mist, blow-by gas). The vortex generator 4 thus forms together with the inner surface 2a of the cavity 3, a helical path whose pitch like that of the screwthread and/or the screwthreads S1, S2 can vary over its length, in particular decreasing in the flow direction. The pitch has a direct influence on the flow cross-section of the flow path SW1, SW2 of the vortex generator 4 so that it is possible to influence the flow rate within the flow path SW1, SW2. For example, locally reducing the flow cross-section A increases the flow rate in the corresponding flow path section.

As shown particularly in FIG. 3, the vortex generator 4 can include at least in certain regions a second screwthread S2. In the illustrated embodiment, the second screwthread S2 extends approximately over one half of a complete 360° revolution. Along the course thereof, it is extends in the same direction (identical directionality) as the first screwthread S1, but is offset with regard to the axial starting point thereof in the flow direction (upstream), offset particularly by approximately the length of one half of a screwthread. This way, it is possible to form, particularly at the beginning of the screwthread at least partially two parallel flow paths SW1, SW2 having a flow resistance that is as small as possible.

The blow-by gas that enters the cavity 3 via the intake port 9 is forced into a swirl by the vortex generator 4, whereby larger centrifugal forces act upon the oil particles suspended in the blow-by gas. The oil particles (droplets and/or solid particles) that are unable to keep up with the flow are thus separated as an oil film on the inner surface 2a of the cavity 3. The centrifugal force that is generated by the vortex generator 4 is great enough for oil particles of a small mass to be separated as well. The flow propels the oil film further downstream.

The vortex generator 4 causes the blow-by gas to swirl so that the proportion and the mass of the oil particles floating in the oil mist increases with increasing radial distance from the axis of the hollow body 2. An oil-separating ring 5, which constitutes a second oil separating step, is provided downstream of the vortex generator 4, located directly inside the area of the gas flow concentrated with oil particles on the inner surface of the cavity. The oil-separating ring 5 is supported in part by the inner surface 2a of the cavity 3. Advantageously, axially extending grooves 5a are distributed over the outer periphery of the oil-separating ring 5 so that the oil-separating ring 5 does not rest against the inner surface 2a of the cavity 3 with all of its outer periphery, and so that the separated oil and/or the oil film flowing along the inner surface 2a is able to flow toward the oil outlet conduit 6.

In an embodiment according to FIGS. 4A to 4G, the oil-separating ring 5 is shown in a variety of preferred configurations. In each configuration, the oil-separating ring 5 constitutes a considerable flow obstacle for flow near the inner surface, thus constituting an impact element. The oil particles floating in the blow-by gas are not able to keep up with the fast directional changes at the oil-separating ring 5, collide with the face of the oil-separating ring 5 and are thus separated from the oil mist. Similarly to the vortex generator 4, the oil-separating ring 5 is mounted in the desired position inside the cavity 3 of the hollow body 2 by processes that are known in the art, envisioning an adhesive bond, form or force connection.

By way of a simple configuration, FIG. 4a provides for the oil-separating ring 5 to be embodied as a massive, circular impact element (circular baffle plate).

In FIG. 4b, the oil-separating ring according to FIG. 4a features a plurality of holes and/or rows of holes. With this configuration, it is possible to mount an arrangement of several identical circular ring disks that are provided one downstream of the other, rotationally offset relative to each other and held together by connecting elements 5b in order to form a composite, constituting a system of cavities that are in communication with each other, such that there results a maze of passages extending completely through the oil-separating ring 5. The face area of the oil-separating ring 5 constitutes, moreover, an impact element, while the maze is a combination of impact and deflecting elements. Using these impact and deflecting elements, even lighter oil particles are separated from the oil mist, such that the oil mist downstream of the oil-separating ring 5 can be regarded as cleaned gas. Possible materials for the above-described configuration of an oil-separating ring 5 can be, for example, porous plastic materials or sintered materials. Preferably, the oil-separating ring 5 also comprises a plastic or metal mesh (FIG. 4c) that creates a plurality of passages and mazes, and wherein the oil-separating ring 5 then preferably comprises a hollow cylindrical support ring T (FIG. 4d) that supports the mesh and serves to fix the mesh in place inside the cavity 3.

In no case does the oil-separating ring 5 rest against the inner surface 2a with its entire outer periphery. Rather, the oil-separating ring 5 includes corresponding grooves 5a along the outer periphery thereof, such that separated oil is able to flow as an oil film along the inner surface 2a of the cavity 3 and through the grooves in the circumferential outer surface of the oil-separating ring 5.

In a further embodiment of the oil-separating ring 5 that is shown in FIGS. 4e and 4f, the sintered material, plastic or metal mesh and/or perforated sheet metal rings are followed, provided downstream thereto when viewed in the flow direction, by a closed ring 50 (end ring) with circumferential radially outward pointing bar sections 50a (support bars for radial support inside the cavity 3). The support ring T, which supports/holds the sintered material, mesh and/or perforated sheet metal rings, prevents oil separated previously in the oil-separating ring from being drawn along toward the center of the hollow body. The closed ring 50 constitutes a further impact element for the flow; it offers the flow during movement thereof through the maze-type separating areas of the oil-separating ring 5 only the possibility of moving radially outward toward the inner surface 2a of the hollow body 2.

The oil mist flows in every case against and/or through the oil-separating ring 5, such that oil particles separate from the oil mist flowing toward and joining the oil film already present on the inner surface of the cavity 3 (due to the first oil separation step “vortex generator”). If, according to a preferred embodiment of the invention, the hollow body 2 is not configured as a rotating and/or rotatably supported body, it is possible to achieve the discharge of the separated oil by mounting the shaft body at an incline (goal: run-off due to the weight and incline) or other suitable measures, such as a special routing of the cleaned gas flow (goal: “entraining” of the separated oil).

Due to the fact that the additional oil separator, which is provided downstream of the vortex generator 4, is configured as a ring, a minimum flow cross-section (inner cross-section of the ring) is always provided for the gas flow. Correspondingly, the oil separator is effectively and reliably protected against loss of function due to freezing or clogging.

Provided downstream of the oil-separating ring 5, for example, at the end of the hollow body 2, there are the oil outlet conduit 6 and the gas outlet conduit 7 (FIG. 1). The oil outlet conduit 6 as well as the gas outlet conduit 7 are connected to the downstream end of the hollow body 2. Since the cleaned gas only flows near the axis of the hollow body 2, the gas outlet conduit 7 or the intake thereof opens axially centrally into the hollow body 2 so that the gas outlet conduit 7 only takes up and discharges clean gas. A discharge tube 12, of T-shape seen in cross section, has a central leg fitted into the hollow body 2 and open on one end, constituting centrally a gas outlet conduit, while forming on the end with the wall of the hollow body 2, an oil outlet conduit 6. On the inside of the hollow body 2, the wall of the central discharge tube 12 protruding into the hollow body 2 maintains a defined axial spacing from the inner surface of the oil-separating ring 5 (and/or the circularly shaped inner wall thereof), so at to form a calm-flow region 11 between the intake of the oil outlet conduit 6 and the oil-separating ring 5, in which the separated oil and/or the oil film can run off almost without being influenced at all by the cleaned gas flowing by. The run-off of the separated oil and/or oil film is supported in an improvement of the oil separator by an inner chamfered edge on the end of the hollow body 2. The angle of the chamfer must be chosen such that, taking into consideration the mounting position of the engine, an independent run-off of the oil can occur following separation even with a stopped engine.

According to an improvement of the oil separator shown in FIG. 5, a bypass passage 21 extends axially inside the vortex generator 4 that can be opened by a bypass valve 22 to provide the blow-by gas with an additional flow passage and thereby ensure a corresponding pressure control within hollow body 2. The bypass passage 21 opens (seen in the flow direction) at the end of the vortex generator 4 into the cavity 3, preferably at an angle of between 0° and 110° (particularly about 90°) relative to the axial axis of the vortex generator 4. The exit angle at which the bypass passage 21 opens into the cavity 3 of the hollow body 2 is preferably dimensioned such that the blow-by gas exiting the bypass passage 21 impinges the oil-separating ring 5 that is provided downstream in the flow direction (flowing against, around and/or through), such that oil separation occurs there that is as efficient as possible. A preferred embodiment envisions that the bypass passage 21 is configured such at its outlet end that the center axis of the exit opening thereof (and/or section of the exit passage) extends as an angle of about 90° relative to the axial axis of the vortex generator 4. The vortex generator 4 is configured such that it divides the cavity 3 of the hollow body 2 in two, in terms of pressure-engineering purposes, separate pressure regions that can be linked by the bypass valve 22. If a pump P connected via the gas outlet conduit 7 and serving to generate the negative pressure in the cavity 3 of the shaft body 2, generates excessively high pressure, or the pressure of the blow-by gas in the outside region of the hollow body is too great, the bypass valves 22 is opened and frees the bypass passage 21 for flow of the blow-by gas. This way, it is possible to maintain the pressure drop via the vortex generator almost constant as a function of the volume of the flow, and the vortex generator 4 can be operated at a preset efficiency.

According to an improvement of the invention as shown in FIGS. 6 and 7, at least one screwthread S1, S2 is configured to be at least partially axially displaceably supported on the core of the vortex generator 4. In particular, at least one screwthread S1, S2 (and/or a wall of the screwthread) is at least partly displaceable on the core of the vortex generator 4, such that the cross-section of the helical flow path can be actively modified or adjusted. An active adjustment of this kind can be achieved, for example, by the gas flow of the blow-by gas itself. The wall (and/or the corresponding screwthread or part thereof) is axially supported for this purpose and/or displaceably supported on the core of the vortex generator 4. A preset force (for example, a (return) spring) holds the displaceable screwthread (portion) in a preset position until such a time that the blow-by gas flowing through generates a force that is greater than the spring force, and the screwthread (or portion thereof) is axially shifted toward is downstream as a function of the flow pressure. In the alternative or in addition, it is possible to axially adjust manually or automatically as a function of predetermined control parameters. The displaceably supported screwthread (or part thereof) is illustrated by stippling, FIG. 7 showing a different operating position of the displaceable screwthread (or part thereof) than the one shown in FIG. 6, which is displaced by a distance x in the flow direction.

FIG. 8 shows an alternative configuration of the hollow body 2 where the vortex generator includes three screwthreads S1, S2, S3 and correspondingly three flow paths SW1, SW2, SW3.

The flow paths SW1, SW2, SW3 of the vortex generator 4 are used as described above to separate oil from the blow-by gas in that, due to a decrease of the width of the flow paths SW1, SW2, SW3 and thereby a decrease of the pitch of the screwthreads S1, S2, S3, the flow rate within the flow paths SW1, SW2, SW3 is increased starting from an upstream end 24. of the vortex generator 4, thereby throwing the oil contained in the blow-by gas radially outward due to the generated centrifugal forces against the inner surface 2a of the hollow body 2. To ensure efficient oil separation, the blow-by gas must have a certain flow rate. The flow rate here is determined substantially by the pressure differential Δp between a second pressure p2 that is in effect at the upstream end 24 of the vortex generator 4 and a first pressure p1 that is in effect in the intermediate space between the vortex generator 4 and the oil-separating ring 5.

To prevent the pressure differential Δp from getting too small with small flow volumes of blow-by gas where the flow rate becomes too low, the cross-section of the flow that is provided for the purpose of the oil separating action is changed depending on pressure.

According to the variant as shown in FIG. 8, a valve body 26 in the form of an inner pin is provided in a chamber 27 of the vortex generator 4 that opens toward the upstream end 24 of the vortex generator 4. The upstream end 24 is directed toward the intake port 9 on the body end.

The functioning of the variant of the hollow body 2 as shown in FIG. 8 can be derived by comparison of FIGS. 8, 10a and 10b, where the valve body 26 is shown in various functional positions with the pressure differential Δp increasing starting from FIG. 8 via FIG. 10a all the way to FIG. 10b. According to FIGS. 8 and 9, the three flow paths SW1, SW2, SW3 are connected to the chamber 27 via respective openings 32a, 32b, 32c. A spring 33 biases the valve body 26 toward a first end position opposite the second pressure p2 acting on the upstream end 24 and the first pressure p1 acting via a central passage 34 of the vortex generator 4 against the opposite end of the valve body 26.

Due to a small volume flow of blow-by gas according to FIG. 8, the pressure differential Δp is so minimal that the force that is exercised by the spring 33 holds the valve body 26 in the first end position. While the opening 32a opening into the first flow path SW1 is always open, in the first end position of the valve bodies 26, the openings 32b, 32c leading into the second and third flow paths SW2, SW3 are closed off by the valve body 26.

With increasing volume flow of blow-by gas, the second pressure p2 also increases on the upstream end, and thereby the pressure differential Δp as well, such that the valve body 26 is displaced downstream against the force of spring 33. With this increasing pressure differential Δp, according to FIGS. 10a and 10b, first the opening 32b that opens into the second flow path SW2, then the third opening 32c that opens in the third flow path SW3 are opened in sequence. Correspondingly, the flow cross-section that is available for oil separation is increased, an excessive increase of the pressure differential can be avoided, and the vortex generator 4 is operated in an optimal range for oil separation.

FIGS. 8, 10a and 10b show in an exemplary manner three functional positions in which one opening 32a, two openings 32a and 32b or all three openings 32a, 32b, and 32c are completely open. In the intermediate positions, which are not shown, the opening 32b leading into the second flow path SW2 and/or the opening 32c leading into the third flow path SW3 are partially opened such that the flow cross-section that is effectively available for the oil separating action changes evenly and continuously over the entire stroke of the valve body 26.

To reduce excess pressure when stress peaks or a malfunction occur, it is possible to easily integrate into the valve body 26 the bypass valve 21 that opens from the upstream end 24 into the passage 34 that then also constitutes a bypass passage.

FIGS. 11 to 13 and FIGS. 14a to 14c relate to an alternate configuration of the hollow body 2 that has a sliding sleeve forming a valve body 26′. While according to the configuration described above, an internal pin is fitted in the valve body 26 of the vortex generator 4, the alternate configuration provides for a sliding sleeve as valve body 26′ that is provided by a sleeve portion between the inner surface 2a of the hollow body 2 and the individual screwthreads S1, S2, S3 of the vortex generator 4. The hollow body 2 has, in addition to the end intake port 9, radial openings 35a, 35b, 35c lying in a radial plane and offset equiangularly at 120°, each opening into a respective one of the flow paths SW1, SW2, SW3 of the vortex generator 4. According to FIGS. 8, 9, 10a and 10b, radial openings 35b and 35c that open into the second and third flow paths SW2 and SW3 are opened and closed, as a function of the effective pressure differential Δp, while the radial opening 35a that opens into the first flow path SW1 is always open, or at least never completely closed.

In order to be able to variably open and close the radial openings 35a, 35b, 35c that are provided along a circumferential line and/or to maintain them open in each functional position, the sliding-sleeve valve body 26′ according to FIG. 11 includes is formed with differently shaped apertures 36a, 36b, 36c. The aperture 36a for the first flow path SW1 and the corresponding radial opening 35a is formed as an axially elongated slot such that the connection of the first flow path SW1 to the environment outside the hollow body 2 is always open. The aperture 36b for the second flow path SW2 and the corresponding radial opening 35b are formed as a shorter slot, such that, with from a small pressure differential Δp, the second flow path SW2 is initially closed. Finally, aperture 36c for the flow path SW3 and the corresponding radial opening 35c are circular, such that the third flow path SW3 is not completely opened until the second end position of the valve body 26′.

The described functional positions are also shown in FIGS. 13, 14a, 14b and 14c. The apertures 36a, 36c working with the first flow path SW1 and the third flow path SW3 are visible in partial section in FIG. 13. FIG. 14a shows in a section rotated by 120° around the axial axis the radial openings 35b, 35c that open into the second and third flow paths SW2, SW3. In the illustrated first end position, only the first flow path SW1 is opened.

As shown in FIGS. 8, 9, 10a and 10b, the valve body 26′ is initially held in position by the spring 33, the first pressure p1 being effective through the central passage 34 within the vortex generator 4 acting upon one end of the valve body 26′, and the second pressure p2 is in effect through the end intake port 9 at the upstream end 24 acting upon the other end of the valve body 26′. Correspondingly, with an increase of the pressure differential Δp, the valve body 26′ is displaced against the return force of the spring 33, such that at first the connection between the second flow path SW2 and the respective radial opening 35b is opened through the corresponding aperture 36b of the valve body 26′ (FIG. 14b). When the pressure differential Δp increases further, the valve body 26′ finally reaches a second end position in which all the flow paths SW1, SW2, SW3 are opened (FIG. 14c).

In order to make the sliding-sleeve valve body 26′ axially movable but held against rotation on the vortex generator 4, the valve body 26′ is formed with axial slots 37 between the apertures 36a, 36b, 36c that engage with the corresponding projections 38 of the vortex generator 4.

FIG. 15a shows a cylinder head cover including a cover body 39 that is covers up at least a camshaft on an engine block. FIG. 15b is an axial section along line A-A of FIG. 15a, showing the camshaft that is covered by the cover body 39. Furthermore, also visible is the previously described hollow body 2 for the separation of oil from the blow-by gas that is provided parallel to the camshaft, laterally offset and immediately below the cover body 39, thereby minimizing the necessary construction space. Blow-by gas that is formed at the engine valves reaches the hollow body through the end intake port 9 and is then cleaned of oil by the vortex generator 4 and the oil-separating ring 5, the separated oil and the cleaned blow-by gas being re discharged separately as described above. A comparison of FIGS. 15b and 15c shows that the cover body 39 as shown in the embodiment, on the one hand, and the hollow body 2, on the other hand, are separate parts, the hollow body 2 being held in place on the cover body 39, for example, by screws.

In the alternative, however, the hollow body 2 can be completely or partially formed by a portion of the cover body 39. FIG. 16 shows a corresponding configuration in which the hollow body 2 is manufactured as an integral component of a single-piece cover body 39. To avoid oil being directly thrown from the camshaft into the intake port 9, it is possible to provide additional elements, such as baffle plates or shutters in the free line of sight between the camshaft 40 and the intake port 9, not shown in the figures to improve clarity.

FIG. 16 shows, furthermore, that even in a configuration without a valve body 26, 26′, providing a radial opening 35 on the body wall can be advantageous. During normal operation, the blow-by gas thus moves through the radial opening 35 the respective flow path SW, while the end intake port 9 with the bypass valve 22 closes the subsequent bypass passage 21 as a function of the pressure.

1. A hollow body formed as a cylindrical tube at least partially having an integrated oil separator, wherein
a vortex generator is provided in a cavity of the hollow body;
the hollow body includes at one end at least one intake port through which oil-entraining gas can be fed to the cavity; and
the hollow body includes at least one outlet port for discharging separated oil and gas that has been freed of oil, characterized in that
an oil-separating ring is provided inside the cavity and, seen in the flow direction, downstream of the vortex generator.

2. The hollow body according to claim 1, wherein the oil-separating ring rests with its outer surface against the inner surface of the hollow body and is formed in its outer surface at least one axially extending groove.

3. The hollow body according to claim 1, wherein the vortex generator includes an integrated bypass passage.

4. The hollow body according to claim 1, wherein the vortex generator is configured as a body extending axially of the hollow body including around the outer surface thereof at least one screwthread, such that a flow path is formed between the body of the vortex generator and the internal wall of the hollow body for routing the introduced oil-entraining gas.

5. The hollow body according to claim 4, wherein the body of the vortex generator has a partial second screwthread, such that there are at least two partially parallel flow paths.

6. The hollow body according to claim 5, wherein a first pressure is present between the vortex generator and the oil-separating ring and a second pressure is present at the upstream end of the vortex generator, a valve body freeing or blocking at the upstream end at least one of the flow paths constituted between the screwthreads as a function of a pressure differential between the second pressure and the first pressure.

7. The hollow body according to claim 6, wherein access to at least one of the flow paths is closed below a preset pressure differential, and upon exceeding the preset pressure differential the valve body opens.

8. The hollow body according to claim 6, wherein the vortex generator includes at least three screwthreads.

9. The hollow body according to claim 6, wherein the valve body is axially movable in the hollow body and is biased by a spring.

10. The hollow body according to claim 6, wherein the valve body is provided in a chamber of the vortex generator that is open toward the upstream end, the flow paths being each connected to the chamber by a respective opening.

11. A cylinder head cover with a hollow body according to claim 1.

12. The cylinder head cover according to claim 11, wherein the hollow body is provided on an inner end of the cover.

13. The cylinder head cover according to claim 11, wherein at least one element is provided upstream of the intake port that prevents any direct throw-in action of oil by a camshaft that is covered up in the mounted state of the cylinder head cover.

14. The cylinder head cover according to claim 11, wherein the hollow body is mounted substantially parallel to a camshaft that is covered up by the cylinder head cover.
